(19) United States
(12) Patent Application Publication
(10) Pub. No.: US 2008/0159550 A1
(43) Pub. Date: Jul. 3, 2008

(54) SIGNAL PROCESSING DEVICE AND AUDIO PLAYBACK DEVICE HAVING THE SAME

(76) Inventors: Yoshiki MATSUMOTO, Osaka (JP); Seigo Suguta, Osaka (JP); Takeshi Fujita, Osaka (JP)

Correspondence Address: MCDERMOTT WILL & EMERY LLP, 600 13TH STREET, NW, WASHINGTON, DC, 20005-3096, US

(21) Appl. No.: 11/950,847

(22) Filed: Dec. 5, 2007

(30) Foreign Application Priority Data
Dec. 28, 2006 (JP) 2006-354890

(51) Int. Cl. H04R 29/00

(52) U.S. Cl. 381/58

(57) ABSTRACT

A signal processing device having an automatic sound field correction function includes: a digital formatting section for converting a signal pair of a test signal and a picked-up sound signal for an automatic sound field correction operation into a bit stream format; and a selecting section for selectively supplying either a bit stream generated by the digital formatting section or an audio bit stream to an existing interface. The selecting section selects the bit stream of the signal pair of the test signal and the picked-up sound signal during trial manufacturing, repairing, maintenance, and the like.

### CROSS REFERENCE TO RELATED APPLICATION

This application claims priority under 35 U.S.C. §119 on Patent Application No. 2006-354890 filed in Japan on Dec. 28, 2006, the entire contents of which are hereby incorporated by reference.

### BACKGROUND OF THE INVENTION

1. Field of the Invention

The invention relates to a signal processing device. More particularly, the invention relates to a device for processing a digital audio signal and an audio playback device having such a device.

2. Background Art

Currently, 5.1 channel formats such as Dolby Digital®, DTS®, and AAC (Advanced Audio Code) have been widely used as an audio compression formats. It is expected that 7.1 channel audio compression formats such as Dolby Digital Plus®, Dolby True HD®, and DTS-HD® will become more and more popular in the future. In these multi-channel audio systems, a plurality of speakers located around the listener output the sounds of respective channels so that the listener can enjoy the real sound experience.

In the multi-channel audio systems, it is ideal that each speaker is located at the same distance from the listener. In fact, however, it is difficult to implement such ideal speaker location due to the room shape, furniture layout, and the like. In order to obtain an optimal sound field with non-ideal speaker location, it is necessary to correct a sound volume and a delay amount of each channel so that the sound volume and the delay amount of each channel is balanced. Listeners used to do such correction by inputting the distance to each speaker and the like to a playback device (such as an AV (Audio-Visual) amplifier and a DVD (Digital Versatile Disc) player). However, such manual correction becomes very complicated as the number of channels increases. Therefore, an audio playback device having an automatic correction function has been proposed (for example, see Japanese Laid-Open Patent Publication Nos. 1-251900 and 6-180591).

In automatic sound field correction, a test signal is sequentially output from each speaker. The respective test signals from the speakers are then picked up by a microphone placed at the listener location and a picked-up sound signal is produced. A sound volume of the picked-up sound signal and a delay amount of the picked-up sound signal from the test signal are then balanced between the channels. Impulse and pink noise can be used as a test signal (for example, see Japanese Laid-Open Patent Publication No. 6-54399). An audio signal of each channel produced by the audio playback device delays and changes in level while passing through the internal circuitry of the device. It further delays and decays by the time the signal from each speaker reaches the listener as aerial vibration. However, the above sound field correction eliminates variation in the delay amount and the sound volume between the channels.

Operation of the automatic sound field correction function of the audio playback device is confirmed by correcting a sound volume and a delay amount of each channel and playing back a sound field confirmation signal by the audio playback device and measuring the sound field confirmation signal by a sound field measuring apparatus. However, the automatic correction function may not work as intended in the following cases: the test signal cannot be detected within the measurement time due to too much delay in the internal circuitry; the picked-up sound signal does not have an appropriate level; the influence of noise is large; and the like. In such cases, it is necessary to retrieve a signal from the internal circuitry and analyze it by using special hardware and software. Debugging will be easier if an interface for outputting an internal signal is provided. However, it is economically disadvantageous to provide a debugging output terminal.

### SUMMARY OF THE INVENTION

In view of the above problems, it is an object of the invention to enable a signal processing device having an automatic sound field correction function to output a test signal and a picked-up sound signal without adding a special interface. It is another object of the invention to provide an audio playback device having such a signal processing device.

More specifically, according to a first aspect of the invention, a signal processing device including a first interface for outputting a multi-channel digital audio signal obtained by decoding an audio bit stream and a second interface for outputting the audio bit stream, for receiving a picked-up sound signal of a test signal outputted from each channel of the first interface and correcting a sound volume and a delay amount of the each channel includes: a digital formatting section for converting a signal pair of the test signal and the picked-up sound signal into a bit stream format; and a selecting section for selectively supplying either a bit stream generated by the digital formatting section or the audio bit stream to the second interface. In this signal processing device, the digital formatting section converts the signal pair of the test signal and the picked-up sound signal into a bit stream format. By selecting the bit stream in the selecting section, the test signal and the picked-up sound signal can be output from the existing second interface.

According to a second aspect of the invention, a signal processing device including a first interface for outputting a multi-channel digital audio signal obtained by decoding an audio bit stream and a second interface for outputting a 2 channel digital audio signal obtained by downmixing the multi-channel digital audio signal, for receiving a picked-up sound signal of a test signal outputted from each channel of the first interface and correcting a sound volume and a delay amount of the each channel includes a selecting section for selectively supplying either a signal pair of the test signal and the picked-up sound signal or the 2 channel digital audio signal to the second interface. By selecting the signal pair of the test signal and the picked-up sound signal in the selecting section, the test signal and the picked-up sound signal can be output from the existing second interface.

According to a third aspect of the invention, a signal processing device including a first interface for outputting a multi-channel digital audio signal obtained by decoding an audio bit stream, a second interface for outputting a 2 channel digital audio signal obtained by downmixing the multi-channel digital audio signal, and a third interface for outputting the audio bit stream, for receiving a picked-up sound signal of a test signal outputted from each channel of the first interface and correcting a sound volume and a delay amount of the each channel includes: a first selecting section for selectively supplying either a signal pair of the test signal and the picked-up sound signal or the 2 channel digital audio signal to the second interface; a digital formatting section for converting the signal pair of the test signal and the picked-up sound signal into a bit stream format; and a second selecting section for selectively supplying either a bit stream generated by the digital formatting section or the audio bit stream to the third interface. By selecting the signal pair of the test signal and the picked-up sound signal in the first selecting section, the test signal and the picked-up sound signal can be output from the existing second interface. Moreover, by converting the signal pair of the test signal and the picked-up sound signal into a bit stream format in the digital formatting section and selecting the bit stream in the second selecting section, the test signal and the picked-up sound signal can be output from the existing third interface.

Preferably, the selecting section or the first and second selecting sections conduct the selection operation according to an external command.

According to a fourth aspect of the invention, an audio playback device includes: the signal processing device of the first, second, or third aspect of the invention; a digital-to-analog (D-A) converter group for conducting digital-to-analog (D-A) conversion of the multi-channel digital audio signal and/or the 2 channel digital audio signal received from the signal processing device; and an analog-to-digital (A-D) converter for conducting analog-to-digital (A-D) conversion of an external audio input to generate the picked-up sound signal.

### BRIEF DESCRIPTION OF THE DRAWINGS

FIG. 1 shows the structure of a 5.1 channel audio system including a signal processing device and an audio playback device according to the invention; and

FIG. 2 is a waveform diagram of a test signal and a picked-up sound signal that are output through a headphone output terminal or a digital output terminal.

### DETAILED DESCRIPTION OF THE PREFERRED EMBODIMENTS

Hereinafter, embodiments of the invention will be described with reference to the accompanying drawings. The following description of the preferred embodiments is essentially by way of example only and is not intended to limit applications or usages of the invention.

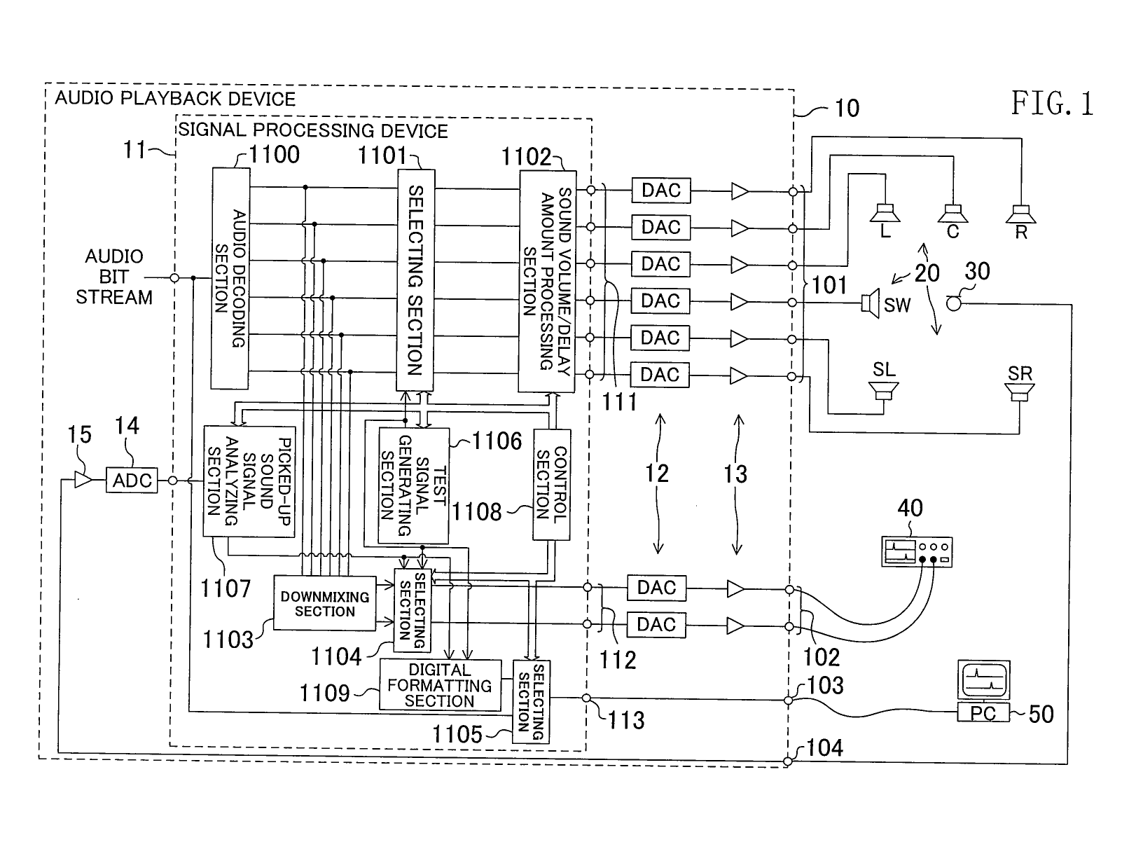

FIG. 1 shows the structure of a 5.1 channel audio system including a signal processing device and an audio playback device according to the invention. An audio playback device 10 includes a signal processing device 11, a digital-to-analog (D-A) converter (DAC) group 12, an amplifier group 13, an analog-to-digital (A-D) converter (ADC) 14, and an amplifier 15. A 5.1 channel digital audio signal and a 2 channel digital audio signal are output from the signal processing device 11, D-A converted by the DAC group 12, and amplified by the amplifier group 13. The resultant analog signals are output from a speaker output terminal 101 and a headphone output terminal 102, respectively. An audio bit stream is output from a digital output terminal 103 such as S/PDIF (Sony/Philips Digital Interface). Sound from a speaker group 20 is picked up by a microphone 30 and applied to the audio playback device 10 through an external audio input terminal 104. This external audio is amplified by the amplifier 15, A-D converted by the ADC 14, and applied to the signal processing device 11 as a picked-up sound signal.

The signal processing device 11 receives an audio bit stream and outputs a 5.1 channel digital audio signal from an interface 111, a 2 channel digital audio signal from an interface 112, and an audio bit stream from an interface 113. During a normal playback operation, the audio bit stream is decoded into a 5.1 channel digital audio signal by an audio decoding section 1100. Each channel of the 5.1 channel digital audio signal is applied to a sound volume/delay amount processing section 1102 through a selecting section 1101. The sound volume and the delay amount of each channel of the 5.1 channel digital audio signal are adjusted by the sound volume/delay amount processing section 1102 and the resultant 5.1 channel digital audio signal is output from the interface 111. The 5.1 channel digital audio signal produced by the audio decoding section 1100 is downmixed into a 2 channel digital audio signal in a downmixing section 1103. This 2 channel digital audio signal is output from the interface 112 through a selecting section 1104. The audio bit stream applied to the signal processing device 11 is output from the interface 113 through a selecting section 1105.

During a sound field correction operation, a test signal is generated by a test signal generating section 1106 and is output as a signal of one of the channels through the selecting section 1011 and the sound volume/delay amount processing section 1102. The test signal is then output from one of the speakers of the speaker group 20 and picked up by the microphone 30. The signal thus picked up is output as a picked-up sound signal from the microphone 30 and the picked-up sound signal is analyzed by a picked-up sound signal analyzing section 1107. Based on the analysis result, a control section 1108 outputs a command to adjust the sound volume and the delay amount of each channel to the sound volume/delay amount processing section 1102. Note that the control section 1108 also controls the selecting sections 1101, 1104, and 1105, the test signal generating section 1106, and the picked-up sound signal analyzing section 1107.

The test signal generating section 1106 supplies a test signal not only to the selecting section 1101 but to the selecting section 1104 and a digital formatting section 1109. The picked-up sound signal analyzing section 1107 also supplies a picked-up sound signal to the selecting section 1104 and the digital formatting section 1109. The picked-up sound signal analyzing section 1107 may supply an output signal of the ADC 14 to the selecting section 1104 and the digital formatting section 1109 as the picked-up sound signal, or may process the output signal of the ADC 14 (e.g., filtering or correlation operation) and then supply the resultant signal to the selecting section 1104 and the digital formatting section 1109 as the picked-up sound signal. The digital formatting section 1109 converts a signal pair of the test signal and the picked-up sound signal into a bit stream format according to a prescribed standard (e.g., IEC60958, AES/EBU (Audio Engineering Society/European Broadcast Union), and ADAT®) and supplies the resultant bit stream to the selecting section 1105.

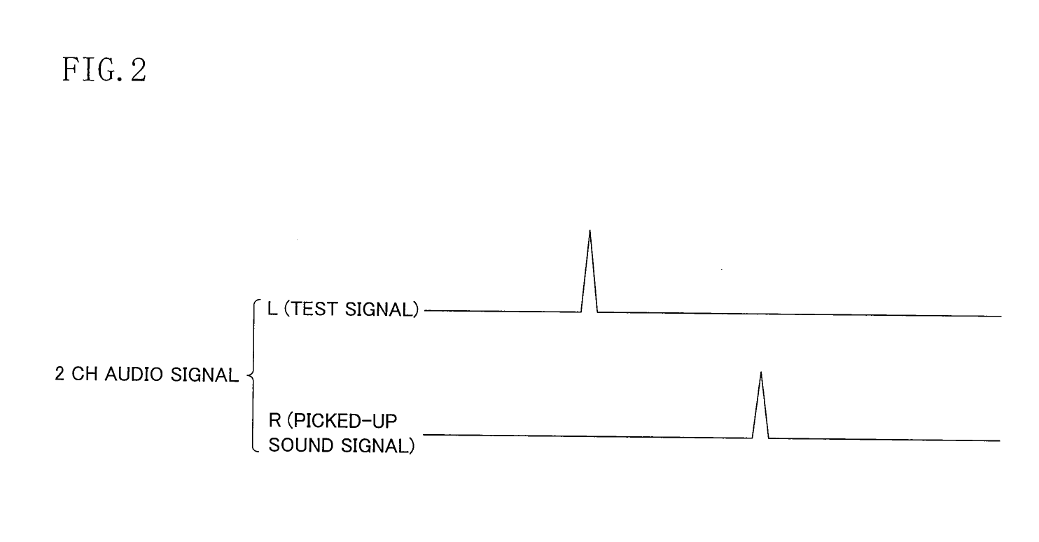

The selecting section 1104 selectively outputs either the signal pair of the test signal and the picked-up sound signal or the 2 channel digital audio signal received from the downmixing section 1103. In particular, the selecting section 1104 outputs the signal pair of the test signal and the picked-up sound signal during trial manufacturing, repairing, maintenance, and the like. By connecting a general-purpose measuring apparatus 40 (e.g., an oscilloscope, a pen recorder, or an audio analyzer) to the headphone output terminal 102, the test signal and the picked-up sound signal can be independently observed in the left and right channels, respectively (see FIG. 2). The difference in level between the test signal and the picked-up sound signal and the delay amount of each of the test signal and the picked-up sound signal can thus be visually confirmed.

The selecting section 1105 selectively outputs either the bit stream received from the digital formatting section 1109 or the audio bit stream applied to the signal processing device 11. In particular, the selecting section 1105 outputs the bit stream received from the digital formatting section 1109 during trial manufacturing, repairing, maintenance, and the like. By connecting the digital output terminal 103 and a personal computer (PC) 50 to each other with a coaxial cable, an optical cable or the like, the test signal and the picked-up sound signal can be independently observed in the PC 50 by using a commercially available waveform display software (see FIG. 2). The difference in level between the test signal and the picked-up sound signal and the delay amount of each of the test signal and the picked-up sound signal can thus be digitized by conducting appropriate data processing in the PC 50.

Note that the selecting sections 1104 and 1105 may output the 2 channel digital audio signal and the audio bit stream during normal use, respectively, and may output the test signal and the picked-up sound signal according to an external command from a remote controller, button operation, or the like during trial manufacturing, repairing, maintenance, and the like.

As has been described above, according to this embodiment, a test signal and a picked-up sound signal for an automatic sound field correction operation can be output from an existing interface such as an interface for outputting a 2 channel digital audio signal and an interface for outputting an audio bit stream. These signals can be simultaneously measured by an analog measuring device and a digital measuring device.

In the case where digital output of the test signal and the picked-up sound signal is not necessary, the selecting section 1105 and the digital formatting section 1109 may be omitted. Similarly, in the case where analog output of the test signal and the picked-up sound signal is not necessary, the selecting section 1104 may be omitted. Moreover, in the case where output of the 2 channel digital audio signal is not necessary, the downmixing section 1103 may be omitted.

Instead of directly applying the test signal and the picked-up sound signal from the test signal generating section 1106 and the picked-up sound signal analyzing section 1107 to the digital formatting section 1109, the 2 channel digital audio signal that is output from the selecting section 1104 may be applied to the digital formatting section 1109.

The signal processing device 11 may be formed by a single integrated circuit (IC). Alternatively, elements such as the audio decoding section 1100, the sound volume/delay amount processing section 1102 and the control section 1108 may be individually formed by a large scale integrated circuit (LSI), an integrated circuit (IC) and the like such as a digital signal processor (DSP), a microcomputer, and a media processor.

The control section 1108 may only output the analysis result of the picked-up sound signal (e.g., a measured level and a measured delay amount of each channel) to the outside and may control the sound volume/delay processing section 1102 according to an external command.

What is claimed is:

1. A signal processing device including a first interface for outputting a multi-channel digital audio signal obtained by decoding an audio bit stream and a second interface for outputting the audio bit stream, for receiving a picked-up sound signal of a test signal outputted from each channel of the first interface and correcting a sound volume and a delay amount of the each channel, comprising:
a digital formatting section for converting a signal pair of the test signal and the picked-up sound signal into a bit stream format; and
a selecting section for selectively supplying either a bit stream generated by the digital formatting section or the audio bit stream to the second interface.

2. The signal processing device according to claim 1, wherein the selecting section conducts the selection operation according to an external command.

3. A signal processing device including a first interface for outputting a multi-channel digital audio signal obtained by decoding an audio bit stream and a second interface for outputting a 2 channel digital audio signal obtained by downmixing the multi-channel digital audio signal, for receiving a picked-up sound signal of a test signal outputted from each channel of the first interface and correcting a sound volume and a delay amount of the each channel, comprising:
a selecting section for selectively supplying either a signal pair of the test signal and the picked-up sound signal or the 2 channel digital audio signal to the second interface.

4. The signal processing device according to claim 3, wherein the selecting section conducts the selection operation according to an external command.

5. A signal processing device including a first interface for outputting a multi-channel digital audio signal obtained by decoding an audio bit stream, a second interface for outputting a 2 channel digital audio signal obtained by downmixing the multi-channel digital audio signal, and a third interface for outputting the audio bit stream, for receiving a picked-up sound signal of a test signal outputted from each channel of the first interface and correcting a sound volume and a delay amount of the each channel, comprising:
a first selecting section for selectively supplying either a signal pair of the test signal and the picked-up sound signal or the 2 channel digital audio signal to the second interface;
a digital formatting section for converting the signal pair of the test signal and the picked-up sound signal into a bit stream format; and
a second selecting section for selectively supplying either a bit stream generated by the digital formatting section or the audio bit stream to the third interface.

6. The signal processing device according to claim 5, wherein the first and second selecting sections conduct the selection operation according to an external command.

7. An audio playback device, comprising:
the signal processing device of claim 1;
a digital-to-analog (D-A) converter group for conducting digital-to-analog (D-A) conversion of the multi-channel digital audio signal received from the signal processing device; and
an analog-to-digital (A-D) converter for conducting analog-to-digital (A-D) conversion of an external audio input to generate the picked-up sound signal.

8. An audio playback device, comprising:
the signal processing device of claim 3;
a digital-to-analog (D-A) converter group for conducting digital-to-analog (D-A) conversion of the multi-channel digital audio signal and the 2 channel digital audio signal received from the signal processing device; and
an analog-to-digital (A-D) converter for conducting analog-to-digital (A-D) conversion of an external audio input to generate the picked-up sound signal.

9. An audio playback device, comprising:
the signal processing device of claim 5;
a digital-to-analog (D-A) converter group for conducting digital-to-analog (D-A) conversion of the multi-channel digital audio signal and the 2 channel digital audio signal received from the signal processing device; and
an analog-to-digital (A-D) converter for conducting analog-to-digital (A-D) conversion of an external audio input to generate the picked-up sound signal.
